(19) United States
(12) Patent Application Publication
(10) Pub. No.: US 2024/0275498 A1
(43) Pub. Date: Aug. 15, 2024

(54) CONTROL OF COMMUNICATION SESSION AUDIO SETTINGS

(71) Applicant: QUALCOMM Incorporated, San Diego, CA (US)

(72) Inventors: Abhishek GHOSH, Kolkata (IN); Sumit RANA, Delhi (IN); Uttkarsh JHA, Araria (IN)

(21) Appl. No.: 18/169,697

(22) Filed: Feb. 15, 2023

(51) Int. Cl. H04B 11/00; H04W 76/15

(52) U.S. Cl. CPC H04B 11/00; H04W 76/15

(57) ABSTRACT

A device includes one or more processors configured to determine, based on a transmission from a second device, data indicative of estimated acoustic coupling to the second device. The one or more processors are further configured to cause the data and an identifier of a multidevice communication session to be sent to an audio controller. The one or more processors are further configured to receive, from the audio controller, an indicator of audio settings associated with the multidevice communication session.

### I. FIELD

The present disclosure is generally related to controlling audio settings associated with multidevice communication sessions.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices can be used to facilitate voice and/or video communication sessions (such as conference calls or videoconferences). Computing devices that support voice communications often include echo reduction functionality to reduce audio echo (also referred to as far-end echo). As one example of far-end echo during a call, a first person speaks into a microphone of a first device to generate first audio data that is sent to a second device. The first audio data is played out at a speaker of the second device as sound, and components of the sound are captured by a microphone of the second device and sent back to the first device as second audio data. In this situation, the second audio data can include components that represent the speech of the first person, which results in the first person hearing her own voice output at the first device (with some delay due to communication with the second device, processing at the second device, etc.). In this example, the second device may implement echo reduction functionality to reduce or remove components of the second audio data that represent sounds received from the first device.

When two or more such devices that are participating in a multidevice communication session are located near to one another, echo reduction can be complicated. To illustrate, returning to the example above, if the first audio data is output by the second device and a third device that is located near the second device, the microphone of the second device can capture sound representing components of the first audio data twice, e.g., once due to output of the first audio data by a speaker of the second device and once due to output of the first audio data by a speaker of the third device. In this situation, the echo reduction functionality of the second device may have difficulty removing both sets of echo components, resulting in echo at the first device.

### III. SUMMARY

According to a particular aspect, a device includes one or more processors configured to determine, based on a transmission from a second device, data indicative of estimated acoustic coupling to the second device. The one or more processors are further configured to cause the data and an identifier of a multidevice communication session to be sent to an audio controller. The one or more processors are further configured to receive, from the audio controller, an indicator of audio settings associated with the multidevice communication session.

According to a particular aspect, a method includes determining, by one or more processors of a first device, data indicative of estimated acoustic coupling to a second device, the data based on a transmission from the second device. The method also includes causing the data and an identifier of a multidevice communication session to be sent to an audio controller. The method further includes receiving, from the audio controller, an indicator of audio settings associated with the multidevice communication session.

According to a particular aspect, a non-transitory computer-readable medium stores instructions that are executable by one or more processors to cause the one or more processors to determine, based on a transmission from a second device, data indicative of estimated acoustic coupling to the second device. The instructions are further executable to cause the data and an identifier of a multidevice communication session to be sent to an audio controller. The instructions are further executable to receive, from the audio controller, an indicator of audio settings associated with the multidevice communication session.

According to a particular aspect, an apparatus includes means for determining data indicative of estimated acoustic coupling of a first device to a second device, the data based on a transmission from the second device. The apparatus also includes means for causing the data and an identifier of a multidevice communication session to be sent to an audio controller. The apparatus further includes means for receiving, from the audio controller, an indicator of audio settings associated with the multidevice communication session.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative aspect of a system operable to control audio settings associated with a multidevice communication session, in accordance with some examples of the present disclosure.

FIG. 2 is a diagram illustrating aspects associated with controlling audio settings associated with a multidevice communication session, in accordance with some examples of the present disclosure.

FIG. 3 illustrates an example of an integrated circuit operable to facilitate control of audio settings associated with a multidevice communication session, in accordance with some examples of the present disclosure.

FIG. 4 is a diagram of a mobile device operable to facilitate control of audio settings associated with a multidevice communication session, in accordance with some examples of the present disclosure.

FIG. 5 is a diagram of a headset operable to facilitate control of audio settings associated with a multidevice communication session, in accordance with some examples of the present disclosure.

FIG. 6 is a diagram of a wearable electronic device operable to facilitate control of audio settings associated with a multidevice communication session, in accordance with some examples of the present disclosure.

FIG. 7 is a diagram of a voice-controlled speaker system operable to facilitate control of audio settings associated with a multidevice communication session, in accordance with some examples of the present disclosure.

FIG. 8 is a diagram of a camera operable to facilitate control of audio settings associated with a multidevice communication session, in accordance with some examples of the present disclosure.

FIG. 9 is a diagram of an extended reality headset operable to facilitate control of audio settings associated with a multidevice communication session, in accordance with some examples of the present disclosure.

FIG. 10 is a diagram of a first example of a vehicle operable to facilitate control of audio settings associated with a multidevice communication session, in accordance with some examples of the present disclosure.

FIG. 11 is a diagram of in-ear devices (e.g., earbuds) operable to facilitate control of audio settings associated with a multidevice communication session, in accordance with some examples of the present disclosure

FIG. 12 is a diagram of a second example of a vehicle operable to facilitate control of audio settings associated with a multidevice communication session, in accordance with some examples of the present disclosure.

FIG. 13 is a diagram of a particular implementation of a method of controlling of audio settings associated with a multidevice communication session that may be performed by the device of FIG. 1, in accordance with some examples of the present disclosure.

FIG. 14 is a block diagram of a particular illustrative example of a device that is operable to facilitate control of audio settings associated with a multidevice communication session, in accordance with some examples of the present disclosure.

### V. DETAILED DESCRIPTION

When two or more devices that are participating in a multidevice communication session are located near one another, echo reduction can be complicated. For example, unwanted acoustic coupling can occur when multiple audio endpoint devices participating in a single communication session are in close physical proximity to one another. As used here, “acoustic coupling” refers to sound output by a speaker of one of the devices being picked up by a microphone of another of the devices. Such acoustic coupling can result in audio feedback and can limit the effectiveness of echo cancellation operations.

Conceptually, acoustic coupling could be reduced by individual users manipulating their respective devices to disable microphones, speakers, or both; however, such manual measures are inconvenient for users and are frequently frustrated by users forgetting to make appropriate configuration changes.

According to particular aspects disclosed herein, transmissions from devices participating in a multidevice communication session are used to determine (or estimate) whether acoustic coupling between the devices is expected to be problematic. In situations where acoustic coupling could be problematic, steps are taken to adjust audio settings of one or more of the devices to reduce the acoustic coupling and thereby to reduce feedback and far-end echo.

In a particular aspect, electromagnetic transmissions (e.g., radiofrequency transmissions) are used to estimate the acoustic coupling between devices. For example, one or more devices may transmit advertisement packets, or similar messages, that are used to estimate acoustic coupling. In this example, transmissions from one device are detected by another device and used to estimate the physical proximity of the devices.

Various techniques can be used to estimate the physical proximity of the devices based on the transmissions. As one example, a packet transmitted by a first device may include data indicating the location of the first device (e.g., a coordinate location based on a global positioning system or a local positioning system). In this example, a second device may determine its own location (e.g., its coordinate location based on the global positioning system or the local positioning system) and determine a distance to the first device based on comparison of the respective locations of the devices.

As another example, a packet transmitted by a first device can include a transmission power indicator of a signal used to transmit the packet. In this example, a second device may estimate a distance between the devices based on comparison of the transmission power indicator and a received signal strength of the signal at the second device. In still other examples, other techniques, such as multilateration, can be used.

An audio controller uses information indicative of estimated acoustic coupling between devices to determine appropriate audio settings for the devices. The audio controller may be a separate device (e.g., a server of a communication service or a local conference system) or may be onboard one of the devices that is participating in the multidevice communication session. The audio settings are selected to limit negative effects of acoustic coupling between co-located devices. For example, the audio settings may be selected to cause all but a subset of the co-located devices to mute their microphones, to mute their speakers, or both. As another example, the audio settings may cause one or more of the co-located devices to adjust gain applied to audio signals.

In some implementations, the audio settings are adjusted remotely, such as at a server of a communication system. For example, the server can receive audio from each of the devices participating in the communication session, but only pass on audio data from a subset of the devices, resulting in server-based muting of audio from devices from which audio data is not passed on. In such implementations, information indicating the audio settings is provided to at least the muted devices. For example, the information indicating the audio settings may be used to generate a display at a particular device indicating that one or more audio transducers (e.g., microphones, speakers, etc.) of the particular device are muted.

In some implementations, the audio settings are adjusted locally at one or more of the devices participating in the communication session. For example, in some such implementations, the indication of audio settings sent by the audio controller to a particular device includes one or more commands instructing the particular device to adjust its settings (e.g., mute one or more microphones, to mute one or more speakers, or to adjust gain applied to one or more audio signals).

A technical benefit of determining the audio settings based on transmissions from co-located devices that are participating in a multidevice communication session is improved echo reduction. For example, when two devices are in one room and both connected to the same multidevice communication session, one of the devices can be muted and the other device can be used to capture audio within the room and to output audio of the multidevice communication session. In this example, a relatively clean audio signal is provided as input to the echo cancellation operations performed onboard the unmuted device since the sound in the room does not include audio output by the muted device, which enables the echo processing operations to remove echo components of the audio signal more effectively. Additionally, computing resources associated with echo cancellation on board both devices are conserved. To illustrate, the muted device performs no echo cancellation operations, and the relatively clean audio signal captured by the unmuted device enables the echo cancellation operations onboard the unmuted device to converge more quickly (relative to a situation in which the audio signal captured by the unmuted device includes audio output from the muted device), thereby conserving processor time and power.

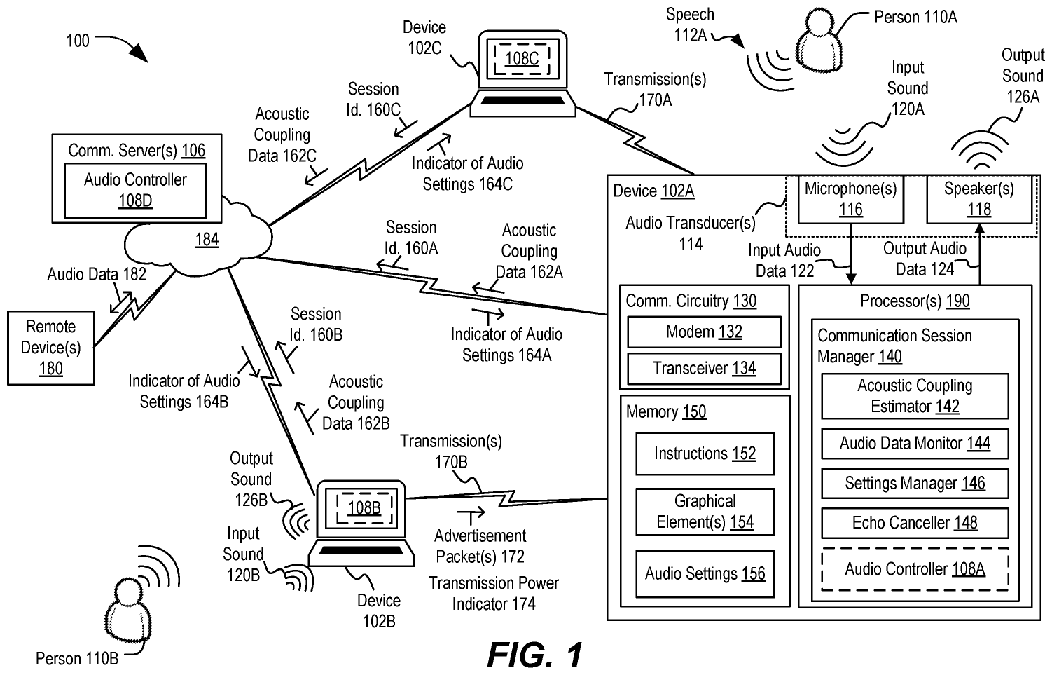

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102A including one or more processors (“processor(s)” 190 of FIG. 1), which indicates that in some implementations the device 102A includes a single processor 190 and in other implementations the device 102A includes multiple processors 190. For ease of reference herein, such features are generally introduced as “one or more” features and are subsequently referred to in the singular or optional plural (as indicated by “(s)”) unless aspects related to multiple of the features are being described.

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter. For example, referring to FIG. 1, multiple devices are illustrated and associated with reference numbers 102A, 102B, and 102C. When referring to a particular one of these devices, such as a device 102A, the distinguishing letter “A” is used. However, when referring to any arbitrary one of these devices or to these devices as a group, the reference number 102 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

In addition to acoustic coupling described above, as used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

FIG. 1 is a block diagram of a particular illustrative aspect of a system 100 operable to control audio settings associated with a multidevice communication session, in accordance with some examples of the present disclosure. In FIG. 1, the system 100 includes multiple devices 102 (including device 102A, 102B, and 102C), which are co-located and participating in a multidevice communication session with one or more remote devices 180. Although FIG. 1 illustrates three co-located devices 102, in other implementations, the system 100 includes more or fewer co-located devices 102. The multidevice communication session includes at least audio data 182. For example, the multidevice communication session can include a conference call or a video conference.

In the system 100, the devices 102 and the remote device(s) 180 communicate via one or more networks 184. In the example illustrated in FIG. 1, one or more communication servers 106 of a communication service are coupled to the network 184 and operable to support the multidevice communication session between the devices 102, 180.

FIG. 1 illustrates a particular example of aspects of the device 102A. While details of the other devices 102B, 102C are not shown in FIG. 1, each of the other devices 102B, 102C may include similar or identical features to those described with reference to the device 102A. In FIG. 1, the device 102A includes communication circuitry 130, one or more audio transducers 114, and memory 150 coupled to one or more processors 190.

In FIG. 1, the communication circuitry 130 includes a modem 132 and a transceiver 134. In a particular aspect, the communication circuitry 130 is configured to support one or more wireless communications protocols, such as a Bluetooth® communication protocol, a Bluetooth® Low-energy (BLE) communication protocol, a Zigbee® communication protocol, a Wi-Fi® communication protocol, one or more other wireless local area network protocols, or any combination thereof (Bluetooth® is a registered trademark of Bluetooth SIG, Inc.; Zigbee® is a registered trademark of Connectivity Standards Alliance; Wi-Fi® is a registered trademark of Wi-Fi Alliance). Additionally, or alternatively, in some implementations, the communication circuitry 130 is configured to support wide-area wireless communication protocols, such as one or more cellular voice and data network protocols from a 3rd Generation Partnership Project (3GPP) standards organization. Further, in some implementations, the communication circuitry 130 is configured to support one or more wired communications protocols. For example, in such implementations, the communication circuitry 130 also includes one or more data ports, such as Ethernet ports, universal serial bus (USB) ports, etc.

According to a particular implementation, the audio transducer(s) 114 include one or more microphones 116, one or more speakers 118, or both. Although the audio transducer(s) 114 are illustrated in FIG. 1 as integrated within the device 102A, in some implementations, one or more of the audio transducer(s) 114 are external to the device 102A and coupled to the processor(s) 190 via one or more audio ports, data ports, or other interface circuitry.

The processor(s) 190 include a communication session manager 140 that is operable to initiate, control, support, or otherwise perform operations associated with the multidevice communication session. For example, the communication session manager 140 may include, correspond to, or be included within an end-user application associated with the communication service. In other examples, the communication session manager 140 is a separate application that facilitates control of the device 102A during the multidevice communication session and possibly at other times. To illustrate, the communication session manager 140 may include a media application or plug-in that interacts with the communication server(s) 106.

In the example illustrated in FIG. 1, particular aspects of the communication session manager 140 are shown, including an acoustic coupling estimator 142, an audio data monitor 144, a settings manager 146, and an echo canceller 148. In some implementations, the communication session manager 140 includes more, fewer, or different components. For example, in some implementations, the communication session manager 140 includes a video conference interface, a chat interface, or other components associated with the communication service. Optionally, as described further below, the communication session manager 140 includes an audio controller 108.

The acoustic coupling estimator 142 is operable to estimate acoustic coupling between the device 102A and one or more other devices, such as the device 102B, the device 102C, or both. In this context, “acoustic coupling” occurs when sound output by an audio transducer of one device is captured by an audio transducer of another device. For example, in FIG. 1, the microphone(s) 116 of the device 102A are operable to generate input audio data 122 based on captured input sound 120A, and the speaker(s) 118 of the device 102A are configured to generate output sound 126A based on output audio data 124. Likewise, in this example, the device 102B is configured to capture input sound 120B and to generate output sound 126B. In this example, acoustic coupling occurs when the output sound 126B is included in the input sound 120A, when the output sound 126A is included in the input sound 120B, or both. An estimate of acoustic coupling is a qualitative or quantitative metric indicative of the magnitude of acoustic coupling between devices. For example, a quantitative estimate of acoustic coupling may indicate a value of a sound level difference (e.g., in dB) between the output sound 126B and a component of the input sound 120A corresponding to the output sound 126B. As another example, a qualitative estimate of acoustic coupling may indicate whether the output sound 126B is expected to contribute significantly to the input sound 120A.

In a particular aspect, the acoustic coupling estimator 142 estimates acoustic coupling based on one or more transmissions 170 from the one or more other devices (e.g., devices 102B and/or 102C). The transmission(s) 170 include modulated electromagnetic waveforms, such as radiofrequency signals, visible light signals, infrared signals, etc. In particular implementations, the acoustic coupling estimator 142 uses the transmission(s) 170 to estimate distance between the device 102A and another device (e.g., the device 102B) and estimates acoustic coupling based on the estimated distance. In some such implementations, the acoustic coupling estimator 142 estimates the distance between the devices based on data represented in the transmission(s) 170. In other implementations, the acoustic coupling estimator 142 estimates the distance between the devices based on the transmission(s) 170 themselves (independent of the content represented by the transmission(s) 170).

In a particular example of estimating the distance between the devices based on the transmission(s) 170 themselves independent of the content represented by the transmission(s) 170, the transmission(s) 170 may be sent according to a particular protocol or pre-arranged settings (e.g., settings established based on user input, instructions from the communication server(s) 106, or negotiations between the devices 102) such that the distance between the devices 102 can be estimated based on characteristics of the transmission(s) 170 at a receiving device. To illustrate, the device 102C can send the transmission(s) 170A at a particular transmission power level, and the device 102A can receive the transmission(s) 170A. Based on the particular protocol or pre-arranged settings associated with the transmission(s) 170A, the device 102A, in this example, is aware of the particular transmission power level used to transmit the transmission(s) 170A. Accordingly, the device 102A can estimate the distance between the device 102A and the device 102C based on the received signal strength of the transmission(s) 170A at the device 102A.

In a particular example of estimating the distance between the devices based on the data represented in the transmission(s) 170, the transmissions 170 can encode data indicating transmission characteristics of the transmission(s) 170, and the distance between the devices 102 can be estimated based on characteristics of the transmission(s) 170 at a receiving device. To illustrate, the device 102B can send the transmission(s) 170B that include one or more advertisement packets 172 associated with a communication protocol supported by the communication circuitry 130. For example, when the communication circuitry 130 supports a BLE communication protocol, the advertisement packet(s) 172 may include BLE advertisement packet(s). The advertisement packet(s) 172 may include a transmission power indicator 174 specifying the particular transmission power level used to transmit the transmission(s) 170B. Optionally, the advertisement packet(s) 172 may also include a session identifier associated with the multidevice communication session. The device 102A, in this example, determines a received signal strength of the transmission(s) 170A at the device 102A and compares the received signal strength to the transmission power indicator 174 to estimate the distance between the device 102A and the device 102B.

In another particular example of estimating the distance between the devices based on the data represented in the transmission(s) 170, the transmission(s) 170 can encode data indicating position information associated with the devices 102C. For example the position information can include a coordinate location based on information from a local or global positioning system. In this example, device 102A compares its own position to the position of the device 102C to estimate the distance between the device 102A and the device 102C.

The acoustic coupling estimator 142 is configured to generate acoustic coupling data 162 indicating the estimated acoustic coupling between two or more devices associated with the multidevice communication session and to provide the acoustic coupling data 162 and a session identifier 160 of the multidevice communication session to the audio controller 108. Optionally, in some implementations, the audio controller 108 is onboard the same device with the acoustic coupling estimator 142. In such implementations, providing the acoustic coupling data 162 and the session identifier 160 to the audio controller 108 includes storing the acoustic coupling data 162 and the session identifier 160 at a designated memory location that is accessible to the audio controller 108. For example, the acoustic coupling estimator 142 of the device 102A in FIG. 1 can store the acoustic coupling data 162 and the session identifier 160 at the memory 150 in a manner that is accessible to the audio controller 108A.

In some implementations, the audio controller 108 is disposed onboard a device distinct from the device with the acoustic coupling estimator 142. For example, in FIG. 1 the acoustic coupling estimator 142 is onboard the device 102A, and the audio controller 108 is disposed onboard one or more of the device 102B, the device 102C, or the communication server(s) 106. In such implementations, providing the acoustic coupling data 162 and the session identifier 160 to the audio controller 108 includes sending the acoustic coupling data 162 and the session identifier 160 to the audio controller 108 via one or more network connections. As one example, in FIG. 1, each of the device 102A, 102B, and 102C is illustrated sending respective acoustic coupling data 162 to the audio controller 108D onboard one or more of the communication server(s) 106. For example, the device 102A transmits acoustic coupling data 162A and a session identifier 160A to the audio controller 108D, the device 102B transmits acoustic coupling data 162B and a session identifier 160B to the audio controller 108D, and the device 102C transmits acoustic coupling data 162C and a session identifier 160C to the audio controller 108D.

According to some aspects, when the devices 102A, 102B, and 102C are all participating in the same multidevice communication session, the session identifiers 160A, 160B, and 160C are identical. For example, each of the session identifiers 160A, 160B, 160C may include a call identifier associated with a conference call. The audio controller 108 uses the session identifiers 160 to determine a set of devices 102 that are participating in the same multidevice communication session.

Each set of acoustic coupling data 162 indicates an estimate of acoustic coupling between the device 102 transmitting the acoustic coupling data 162 and one or more other devices. To illustrate, the acoustic coupling data 162A transmitted by the device 102A indicates estimated acoustic coupling between the device 102A and one or more other devices (e.g., the device 102B, the device 102C, one or more other devices 102, or any combination thereof). Similarly, the acoustic coupling data 162B transmitted by the device 102B indicates estimated acoustic coupling between the device 102B and one or more other devices (e.g., the device 102A, the device 102C, one or more other devices 102, or any combination thereof), and the acoustic coupling data 162C transmitted by the device 102C indicates estimated acoustic coupling between the device 102C and one or more other devices (e.g., the device 102A, the device 102B, one or more other devices 102, or any combination thereof).

The audio controller 108 determines audio settings 156 for one or more of the devices 102 based on the acoustic coupling data 162. In a particular aspect, the audio settings 156 are selected to limit or control acoustic coupling between the devices 102. In a particular implementation, the audio settings 156 are selected to limit far-end echo. For example, in FIG. 1, one or more remote devices 180 are participating in the multidevice communication session with the devices 102. In this situation, the remote device(s) 180 exchange audio data 182 with the devices 102. When audio data 182 from the remote device(s) 180 (referred to herein as “far-end audio data”) is received by one of the devices 102, such as the device 102A, the device 102A typically generates the output sound 126A based on the far-end audio data. The microphone(s) 116 of the device 102A capture the input sound 120A, which may include portions of the output sound 126A as well as other sounds, such as speech 112 from one or more persons 110 co-located with the device 102A. The echo canceller 148 is operable to perform echo cancellation operations to remove components of the input sound 120A that correspond to the audio data 182 output by the device 102A. In general, the echo cancellation operations include buffering the audio data 182 for an echo delay period, then subtracting the delayed audio data 182 from the input sound 120A.

The echo delay period used by the echo canceller 148 is generally relatively short and intended to reduce echo at the remote device(s) 180 due to acoustic coupling between microphone(s) 116 and speaker(s) 118 of a single device (e.g., the device 102A). When two or more devices 102 participating in a multidevice communication session with the remote device(s) 180 are co-located, as illustrated in FIG. 1, the audio data 182 can be output by multiple of the devices 102, such as by the device 102A and the device 102B, in which case the input sound 120A captured by the device 102A will include components of the far-end audio output by the device 102A and components of the far-end audio output by the device 102B. The echo canceller 148 is generally not configured to deal with components of the far-end audio output by other devices (e.g., the device 102B in this example). As a result, despite proper operation of the echo canceller 148, the remote device(s) 180 may experience echo due to the components of the far-end audio output by the device 102B and capture by the microphone(s) 116 of the device 102A.

In a particular aspect, the audio controller 108 selects audio settings 156 for one or more of the co-located devices (e.g., the devices 102) participating in a multidevice communication session to limit or control far-end echo due to acoustic coupling between the co-located devices. As a specific example, the audio setting 156 can include muting or adjusting gain associated with output sound 126 produced by one or more of the devices 102. As another specific example, the audio setting 156 can include muting or adjusting gain associated with input sound 120 captured at one or more of the devices 102. As yet another specific example, the audio setting 156 can include muting or adjusting gain associated with input sound 120 captured at one or more of the devices 102 and muting or adjusting gain associated with output sound 126 produced by the same devices 102 or produced by one or more others of the devices 102.

After selecting audio settings 156 for a particular device 102, the audio controller 108 is configured to send an indicator 164 of the audio settings 156 to at least the particular device 102. For example, in FIG. 1, the audio controller 108 sends the indicator 164A of the audio settings 156 associated with the device 102A to the device 102A. Likewise, the audio controller 108 sends the indicators 164B and 164C to the devices 102B and 102C, respectively.

In some implementations, the audio settings 156 associated with a specific device 102 (e.g., the device 102A) are implemented locally at the specific device 102. For example, the indicator 164A associated with the device 102A may include one or more commands to adjust the audio settings 156 of the device 102A. In some such examples, the settings manager 146 automatically updates the audio settings 156 of the device 102A based on the indicator 164A. To illustrate, the settings manager 146 may adjust a gain associated with at least one audio transducer 114. In other such examples, the indicator 164 includes one or more prompts to request that a user adjust the gain associated with the at least one audio transducer.

In some implementations, the audio settings 156 associated with a specific device 102 (e.g., the device 102A) are implemented remotely from the specific device 102. For example, the communication server(s) 106 may adjust the audio settings 156 of the device 102A. In this example, the indicator 164A provided to the device 102A may include one or more graphical elements 154 associated with the communication session and indicating how the communication server(s) 106 are processing audio to and/or from the device 102A based on the audio settings 156. In this example, operation of the device 102A is not changed due to adjustment of the audio settings; however, the audio data 182 provided to various devices 102, 180 by the communication server(s) 106 based on the audio settings 156 may be changed.

To illustrate, before the audio settings 156 are adjusted, the audio data 182 sent to the remote device(s) 180 by the communication server(s) 106 may include data representing the input sound 120A captured at the device 102A; however, after the audio settings 156 are adjusted, the audio data 182 sent to the remote device(s) 180 by the communication server(s) 106 may omit the data representing the input sound 120A captured at the device 102A. In this illustrative example, the audio from the device 102A is muted from the multidevice communication session based on the audio settings 156. The device 102A may nevertheless continue to capture the input sound 120A and optionally to send audio data 182 representing the input sound 120A to the communication server(s) 106. For example, the device 102A sends the audio data 182 representing the input sound 120A to the communication server(s) 106, and the communication server(s) 106 do not pass the audio data 182 representing the input sound 120A to other devices. In such implementations, the indicator 164A sent to the device 102A may include, for example, a graphical element 154 for display in a graphical user interface associated with the multidevice communication session, where the graphical element 154 indicates that audio of the device 102A is muted from the multidevice communication session.

In some implementations, the audio settings 156 are selected such that far-end audio (e.g., audio data from the remote device(s) 180 in the example of FIG. 1) is played out at only one device of a set of co-located devices 102 that are participating in a multidevice communication session and that are associated with greater than a threshold level of acoustic coupling. For example, in FIG. 1, when the devices 102A, 102B, and 102C are each participating in the same communication session and the acoustic coupling estimator 142 of the device 102A determines that unacceptable (e.g., greater than the threshold) acoustic coupling is likely to be present between the device 102A and each of the devices 102B and 102C, the audio controller 108 may select the audio settings 156 such that only a particular one of the devices 102A, 102B, and 102C outputs the far-end audio. In some such implementations, an output volume of the particular device selected to output the far-end audio may be increased based on the estimated acoustic coupling such that the far-end audio is readily perceivable by users associated with the devices 102.

Additionally, or alternatively, in some implementations, the audio settings 156 are selected such that the remote device(s) 180 are provided audio data 182 from only one device of a set of the co-located devices 102 that are participating in a multidevice communication session and that are associated with greater than a threshold level of acoustic coupling. For example, in FIG. 1, when the devices 102A, 102B, and 102C are each participating in the same communication session and the acoustic coupling estimator 142 of the device 102A determines that unacceptable (e.g., greater than the threshold) acoustic coupling is likely to be present between the device 102A and each of the devices 102B and 102C, the audio controller 108 may select the audio settings 156 such that the audio data 182 provided to the remote device(s) 180 include only input sound 120 captured by a particular one of the devices 102A, 102B, and 102C. In some such implementations, gain associated with the microphone(s) 116 of the particular device may be increased based on the estimated acoustic coupling.

In some situations, after the audio settings 156 are adjusted, the audio settings 156 can be updated based on activity in an area where the devices 102 are located. For example, the audio settings 156 may be initially set based on the acoustic coupling data 162 as described above. In this example, the audio data monitor 144 of one or more of the devices 102 can monitor the input sound 120 captured at the device 102 to detect changes in a sound environment of the devices 102 (e.g. by detecting changes in audio data representing the input sound 120). In this example, based on detecting one or more changes in the audio data, the audio data monitor 144 may cause selection data based on the audio data to be sent to the audio controller 108. The selection data may indicate, for example, that the audio settings 156 should be updated due to the changes in the audio data. To illustrate, the changes in the audio data may indicate that a person (e.g., the person 110A or a person 110B) who is speaking is moving about a room where the devices 102 are located. In this situation, a best microphone to capture input sound 120 representing the speech 112A of the person 110A may change depending on the location and orientation of the person 110A within the room. The selection data facilitate selection, by the audio controller 108, of one or more microphones to best capture input sound 120 including the speech 112A of the person 110A. Responsive to the selection data, the audio controller 108 may send an updated indicator 164 of the audio settings 156.

One benefit of using the transmission(s) 170 to estimate the acoustic coupling between the devices 102 is that using the transmission(s) 170 allows the audio settings 156 to be adjusted independently of communication of audio data 182 via a communication session. For example, the audio settings 156 for a conference call or a video call can be configured during a set up process, rather than during the call, which reduces far-end echo experienced during early portions of the call. An additional benefit is better echo reduction since the echo canceller 148 is generally not designed to, and may be unable to, reduce echo associated with other co-located devices.

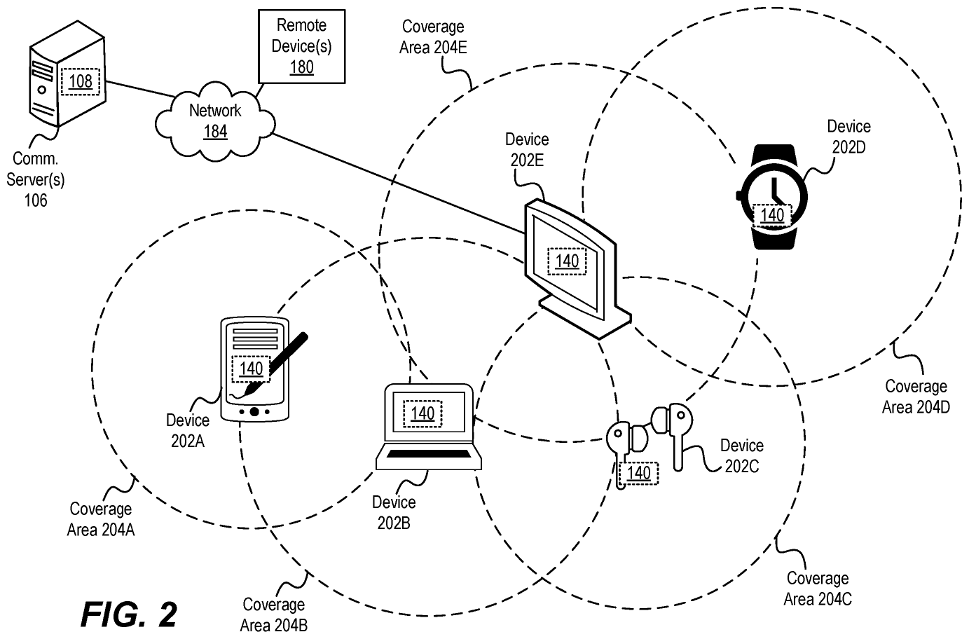

FIG. 2 is a diagram of an illustrative aspect of operations associated with controlling audio settings associated with a multidevice communication session, in accordance with some examples of the present disclosure. In the example illustrated in FIG. 2, a plurality of devices 202 are co-located and participating in a multidevice communication session with the remote device(s) 180. FIG. 2 also illustrates the network 184 and the communication server(s) 106 of FIG. 1.

The co-located devices 202 in the example of FIG. 2 include a tablet computing device 202A, a laptop computing device 202B, earbuds 202C, a wearable device 202D (illustrated as a watch), and a stationary computing device 202E. The specific device types of the devices 202 are merely illustrative of one example and are not intended to be limiting. In the example illustrated in FIG. 2, each of the devices 202 includes an instance of the communication session manager 140 of FIG. 1. Additionally in FIG. 2, the audio controller 108 is located at the communication server(s) 106.

Each of the devices 202 is associated with a respective coverage area 204. The coverage area 204 of each device 202 represents a range in which transmissions 170 from the device 202 are expected to be detectable by other devices 202. For example, a coverage area 204A of the tablet computing device 202A represents an area in which transmissions from the tablet computing device 202A are expected to be useful for estimating acoustic coupling associate with the tablet computing device 202A. Similarly, a coverage area 204B represents an area in which transmissions from the laptop computing device 202B are expected to be useful for estimating acoustic coupling, a coverage area 204C represents an area in which transmissions from the earbuds 202C are expected to be useful for estimating acoustic coupling, a coverage area 204D represents an area in which transmissions from the wearable device 202D are expected to be useful for estimating acoustic coupling, and a coverage area 204E represents an area in which transmissions from the stationary computing device 202E are expected to be useful for estimating acoustic coupling. Whether particular transmissions will be useful for estimating acoustic coupling is to some extent a function of the device receiving the transmission as well as the device sending the transmission, as such the coverage areas 204 shown in FIG. 2 are merely notional and for illustrative purposes.

During operation of the devices 202 according to a particular implementation, one or more of the devices 202 can send transmissions (e.g., the transmission(s) 170 of FIG. 1) that others of the devices 202 can use to estimate acoustic coupling. For example, the tablet computing device 202A can send transmissions that can be detected by the laptop computing device 202B. In this example, the communication session manager 140 of the laptop computing device 202B can estimate acoustic coupling between the tablet computing device 202A and the laptop computing device 202B based on the transmissions. In this example, the other devices 202C-202E are outside the coverage area 204A of the tablet computing device 202A and do not receive the transmissions from the tablet computing device 202A or are unable to estimate acoustic coupling with the tablet computing device 202A (e.g., due to attenuation of the transmissions).

Further, in FIG. 2, the laptop computing device 202B may send transmissions that can be detected by devices 202 within the coverage area 204B, such as the tablet computing device 202A, the earbuds 202C, and the stationary computing device 202E. The communication session managers 140 of the tablet computing device 202A, the earbuds 202C, and the stationary computing device 202E can estimate acoustic coupling between the laptop computing device 202B and each of the tablet computing device 202A, the earbuds 202C, and the stationary computing device 202E, respectively, based on the transmissions. Likewise, the earbuds 202C may send transmissions that can be detected by devices 202 within the coverage area 204C, such as the laptop computing device 202B and the stationary computing device 202E. The communication session managers 140 of the laptop computing device 202B and the stationary computing device 202E can estimate acoustic coupling between the earbuds 202C and each of the laptop computing device 202B and the stationary computing device 202E, respectively, based on the transmissions. Similarly, the wearable device 202D may send transmissions that can be detected by devices 202 within the coverage area 204D, such as the stationary computing device 202E. The communication session managers 140 of the stationary computing device 202E can estimate acoustic coupling between the wearable device 202D and the stationary computing device 202E based on the transmissions. Additionally, the stationary computing device 202E may send transmissions that can be detected by devices 202 within the coverage area 204E, such as the laptop computing device 202B, the earbuds 202C, and the wearable device 202D. The communication session managers 140 of the laptop computing device 202B, the earbuds 202C, and the wearable device 202D can estimate acoustic coupling between the stationary computing device 202E and each of the laptop computing device 202B, the earbuds 202C, and the wearable device 202D, respectively, based on the transmissions.

In some implementations, each of the devices 202 sends acoustic coupling data (e.g., the acoustic coupling data 162 of FIG. 1) and a session identifier (e.g., the session identifier 160 of FIG. 1) to the audio controller 108. In some such implementations, one or more of the devices 202 routes the acoustic coupling data and the session identifier to the audio controller 108 via one or more others of the devices 202. For example, the stationary computing device 202E may facilitate communication of the acoustic coupling data from the tablet computing device 202A, the laptop computing device 202B, the earbuds 202C, the wearable device 202D, or a combination thereof, to the audio controller 108. To illustrate, the stationary computing device 202E may correspond to an infrastructure device within a conference room, such as a conference call or video call control device, that facilitates connection of the other devices 202 to the network 184 to support the multidevice communication session. In such implementations, the device 202 that routes acoustic coupling data to the audio controller 108 may aggregate the acoustic coupling data (e.g. to generate a table or other data structure indicating estimates of acoustic coupling between devices) and add the session identifier to the aggregated acoustic coupling data before sending the aggregated acoustic coupling data to the audio controller 108.

The audio controller 108 determines audio settings (e.g., the audio settings 156) for one or more of the devices 202 and sends an indicator (e.g., the indicator 164) of the audio settings for each device 202 to the respective device 202. The audio settings associated with the devices 202 are updated, as determined by the audio controller 108, such that far end echo experienced at the remote device(s) 180 is reduced. In a particular implementation, if a single aggregating device (such as the stationary computing device 202E) routes the acoustic coupling data from multiple devices 202 to the audio controller 108, the audio controller 108 may send the indicators of the audio settings for each device 202 to the aggregating device for distribution to the other devices 202. One benefit of aggregating the acoustic coupling data and/or the indicators of the audio settings is that the devices 202 do not each need a separate connection to the audio controller 108; thus, communication resources (e.g., bandwidth and availability) are conserved. Additionally, in some cases, power of the devices 202 can be conserved if lower power transmitters can be used to communicate with the aggregating device than would be used to communicate with the communication server(s) 106.

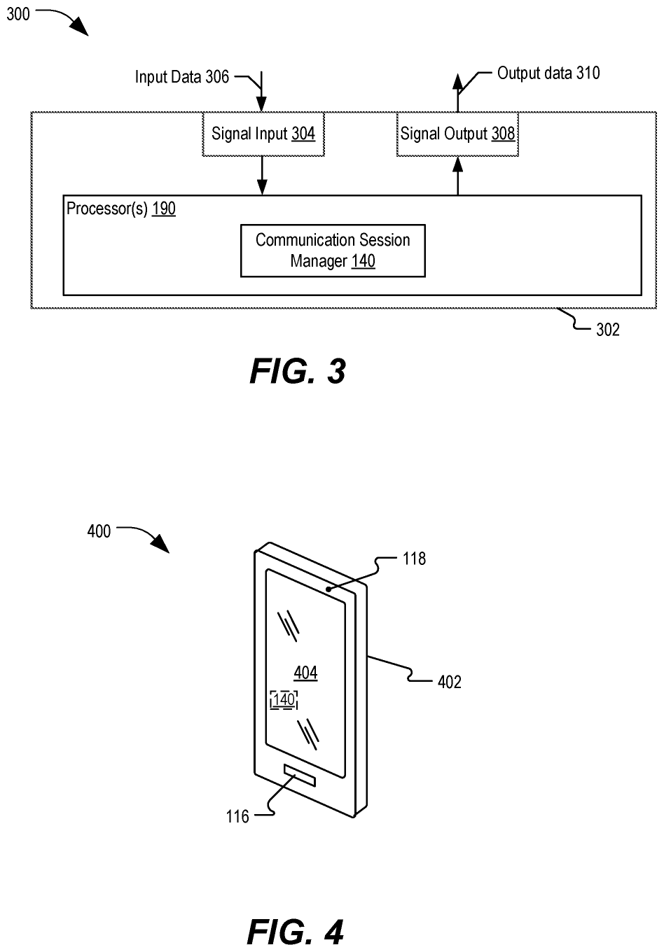

FIG. 3 depicts an implementation 300 in which an integrated circuit 302 includes the one or more processors 190 of the device 102A of FIG. 1. The integrated circuit 302 also includes a signal input 304, such as one or more bus interfaces, to receive input data 306 for processing. For example, the input data 306 may include data from the communication circuitry 130, the audio transducer(s) 114, or the memory 150 of FIG. 1, such as data derived from the transmission(s) 170, the transmission power indicator 174, a received signal strength of one or more of the transmission(s) 170, location information from a positioning system, the session identifier 160, the acoustic coupling data 162, audio data representing the input sound 120, the audio data 182, the indicator 164 of the audio settings 156, other data associated with a multidevice communication session, or a combination thereof.

The integrated circuit 302 also includes a signal output 308, such as a bus interface, to enable sending of output data 310. For example, the output data 310 may include data provided by the processor(s) 190 to one or more of the communication circuitry 130, the audio transducer(s) 114, or the memory 150 of FIG. 1, such as the session identifier 160, the acoustic coupling data 162, audio data representing the output sound 126, the indicator 164 of the audio settings 156, other data associated with a multidevice communication session, or a combination thereof.

FIG. 4 depicts an implementation 400 in which one of the devices 102 of FIG. 1 is a mobile device 402, such as a phone or tablet, as illustrative, non-limiting examples. The mobile device 402 includes the microphone(s) 116, the speaker(s) 118, and a display screen 404. Components of the processor(s) 190, including the communication session manager 140, are integrated in the mobile device 402 and are illustrated using dashed lines to indicate internal components that are not generally visible to a user of the mobile device 402.

In a particular example, the mobile device 402 is configured to receive transmissions from other devices that are participating in a multidevice communication session with the mobile device 402. In this example, the communication session manager 140 is configured to determine, based on a transmission from another device participating in the multidevice communication session, data indicative of estimated acoustic coupling to the other device. The communication session manager 140 is further configured to cause the data indicative of the estimated acoustic coupling and an identifier of the multidevice communication session to be sent to an audio controller, and to receive, from the audio controller, an indicator of audio settings associated with the multidevice communication session. In implementations in which the indicator of the audio settings includes a graphical element, the display screen 404 is operable to display the graphical element to a user. In implementations in which the communication session manager 140 of the mobile device 402 includes the audio controller, the mobile device 402 may also be operable to receive acoustic coupling data from the other devices participating in the multidevice communication session, to determine audio settings for one or more of the other devices, and to send an indication of the audio settings to the one or more other devices.

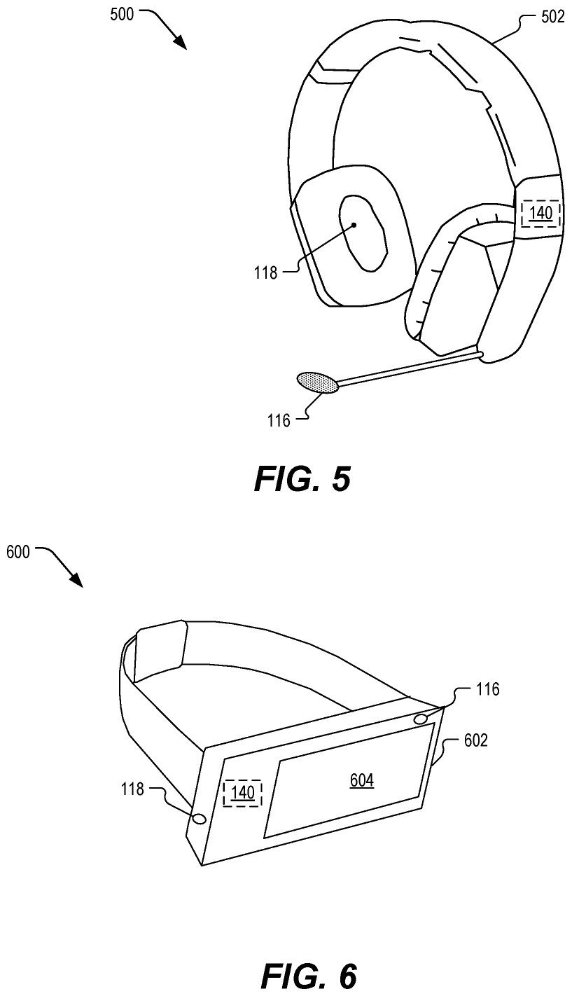

FIG. 5 depicts an implementation 500 in which one of the devices 102 of FIG. 1 is a headset device 502. The headset device 502 includes the microphone(s) 116 and the speaker(s) 118. Components of the processor 190, including the communication session manager 140, are integrated in the headset device 502. In a particular example, the headset device 502 is configured to receive transmissions from other devices that are participating in a multidevice communication session with the headset device 502. In this example, the communication session manager 140 is configured to determine, based on a transmission from another device participating in the multidevice communication session, data indicative of estimated acoustic coupling to the other device. The communication session manager 140 is further configured to cause the data indicative of the estimated acoustic coupling and an identifier of the multidevice communication session to be sent to an audio controller, and to receive, from the audio controller, an indicator of audio settings associated with the multidevice communication session. To illustrate, the audio settings may indicate that audio from the headset device 502 is not being provided to other devices participating in the multidevice communication session. In implementations in which the communication session manager 140 of the headset device 502 includes the audio controller, the headset device 502 may also be operable to receive acoustic coupling data from the other devices participating in the multidevice communication session, to determine audio settings for one or more of the other devices, and to send an indication of the audio settings to the one or more other devices.

FIG. 6 depicts an implementation 600 in which one of the devices 102 of FIG. 1 is a wearable electronic device 602, illustrated as a “smart watch.” The wearable electronic device 602 includes the microphone(s) 116, the speaker(s) 118, and a display screen 604. Components of the processor(s) 190, including the communication session manager 140, are integrated in the wearable electronic device 602.

In a particular example, the wearable electronic device 602 is configured to receive transmissions from other devices that are participating in a multidevice communication session with the wearable electronic device 602. In this example, the communication session manager 140 is configured to determine, based on a transmission from another device participating in the multidevice communication session, data indicative of estimated acoustic coupling to the other device. The communication session manager 140 is further configured to cause the data indicative of the estimated acoustic coupling and an identifier of the multidevice communication session to be sent to an audio controller, and to receive, from the audio controller, an indicator of audio settings associated with the multidevice communication session. In implementations in which the indicator of the audio settings includes a graphical element, the display screen 604 is operable to display the graphical element to a user. In implementations in which the communication session manager 140 of the wearable electronic device 602 includes the audio controller, the wearable electronic device 602 may also be operable to receive acoustic coupling data from the other devices participating in the multidevice communication session, to determine audio settings for one or more of the other devices, and to send an indication of the audio settings to the one or more other devices.

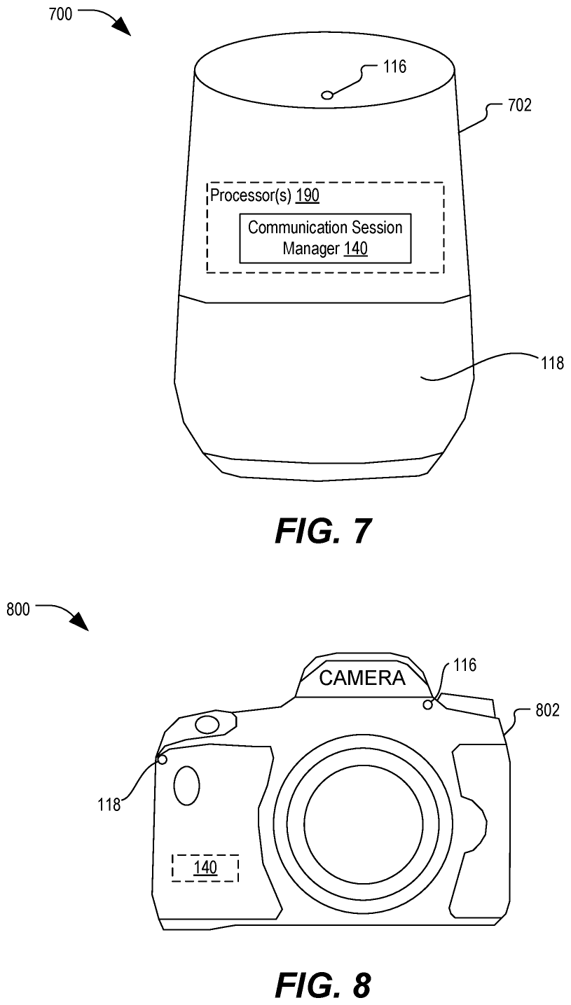

FIG. 7 is an implementation 700 in which one of the devices 102 of FIG. 1 is a wireless speaker and voice activated device 702. The wireless speaker and voice activated device 702 can have wireless network connectivity and is configured to execute an assistant operation. The wireless speaker and voice activated device 702 includes the microphone(s) 116 and the speaker(s) 118. Components of the processor(s) 190, including the communication session manager 140, are integrated in the wireless speaker and voice activated device 702.

In a particular example, the wireless speaker and voice activated device 702 is configured to receive transmissions from other devices that are participating in a multidevice communication session with the wireless speaker and voice activated device 702. In this example, the communication session manager 140 is configured to determine, based on a transmission from another device participating in the multidevice communication session, data indicative of estimated acoustic coupling to the other device. The communication session manager 140 is further configured to cause the data indicative of the estimated acoustic coupling and an identifier of the multidevice communication session to be sent to an audio controller, and to receive, from the audio controller, an indicator of audio settings associated with the multidevice communication session. In implementations in which the communication session manager 140 of the wireless speaker and voice activated device 702 includes the audio controller, the wireless speaker and voice activated device 702 may also be operable to receive acoustic coupling data from the other devices participating in the multidevice communication session, to determine audio settings for one or more of the other devices, and to send an indication of the audio settings to the one or more other devices.

FIG. 8 depicts an implementation 800 in which one of the devices 102 of FIG. 1 is a portable electronic device that corresponds to a camera device 802. The camera device 802 includes the microphone(s) 116, the speaker(s) 118, and optionally a display screen (e.g., on a side not visible in FIG. 8). Components of the processor(s) 190, including the communication session manager 140, are integrated in the camera device 802.

In a particular example, the camera device 802 is configured to receive transmissions from other devices that are participating in a multidevice communication session with the camera device 802. In this example, the communication session manager 140 is configured to determine, based on a transmission from another device participating in the multidevice communication session, data indicative of estimated acoustic coupling to the other device. The communication session manager 140 is further configured to cause the data indicative of the estimated acoustic coupling and an identifier of the multidevice communication session to be sent to an audio controller, and to receive, from the audio controller, an indicator of audio settings associated with the multidevice communication session. In implementations in which the indicator of the audio settings includes a graphical element, the display screen, if present, is operable to display the graphical element to a user. In implementations in which the communication session manager 140 of the camera device 802 includes the audio controller, the camera device 802 may also be operable to receive acoustic coupling data from the other devices participating in the multidevice communication session, to determine audio settings for one or more of the other devices, and to send an indication of the audio settings to the one or more other devices.

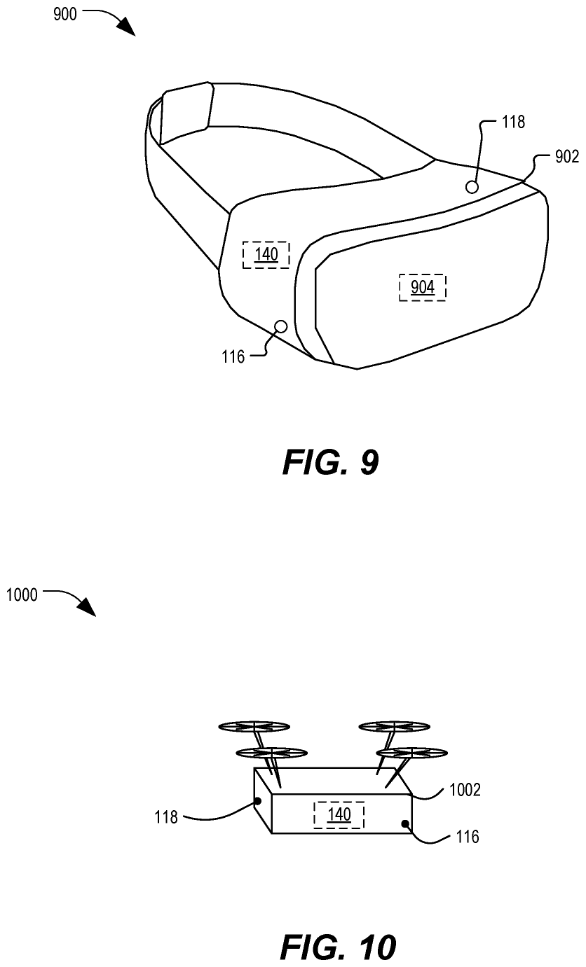

FIG. 9 depicts an implementation 900 in which one of the devices 102 of FIG. 1 is a portable electronic device that corresponds to an extended reality headset 902 (e.g., a virtual reality, mixed reality, or augmented reality headset). The extended reality headset 902 includes the microphone(s) 116, the speaker(s) 118, and a display screen 904. The display screen 904 is disposed on a surface that is positioned in front of a user's eyes when the extended reality headset 902 is worn. Components of the processor(s) 190, including the communication session manager 140, are integrated in the extended reality headset 902.

In a particular example, the extended reality headset 902 is configured to receive transmissions from other devices that are participating in a multidevice communication session with the extended reality headset 902. In this example, the communication session manager 140 is configured to determine, based on a transmission from another device participating in the multidevice communication session, data indicative of estimated acoustic coupling to the other device. The communication session manager 140 is further configured to cause the data indicative of the estimated acoustic coupling and an identifier of the multidevice communication session to be sent to an audio controller, and to receive, from the audio controller, an indicator of audio settings associated with the multidevice communication session. In implementations in which the indicator of the audio settings includes a graphical element, the display screen 904 is operable to display the graphical element to a user. In implementations in which the communication session manager 140 of the extended reality headset 902 includes the audio controller, the extended reality headset 902 may also be operable to receive acoustic coupling data from the other devices participating in the multidevice communication session, to determine audio settings for one or more of the other devices, and to send an indication of the audio settings to the one or more other devices.

FIG. 10 depicts an implementation 1000 in which one of the devices 102 of FIG. 1 corresponds to, or is integrated within, a vehicle 1002, illustrated as a manned or unmanned aerial device (e.g., a drone capable of facilitating communication sessions, such as a conference call drone). The vehicle 1002 includes the microphone(s) 116 and the speaker(s) 118. Components of the processor(s) 190, including the communication session manager 140, are integrated in the vehicle 1002.

In a particular example, the vehicle 1002 is configured to receive transmissions from other devices that are participating in a multidevice communication session with the vehicle 1002. In this example, the communication session manager 140 is configured to determine, based on a transmission from another device participating in the multidevice communication session, data indicative of estimated acoustic coupling to the other device. The communication session manager 140 is further configured to cause the data indicative of the estimated acoustic coupling and an identifier of the multidevice communication session to be sent to an audio controller, and to receive, from the audio controller, an indicator of audio settings associated with the multidevice communication session. In implementations in which the communication session manager 140 of the vehicle 1002 includes the audio controller, the vehicle 1002 may also be operable to receive acoustic coupling data from the other devices participating in the multidevice communication session, to determine audio settings for one or more of the other devices, and to send an indication of the audio settings to the one or more other devices.

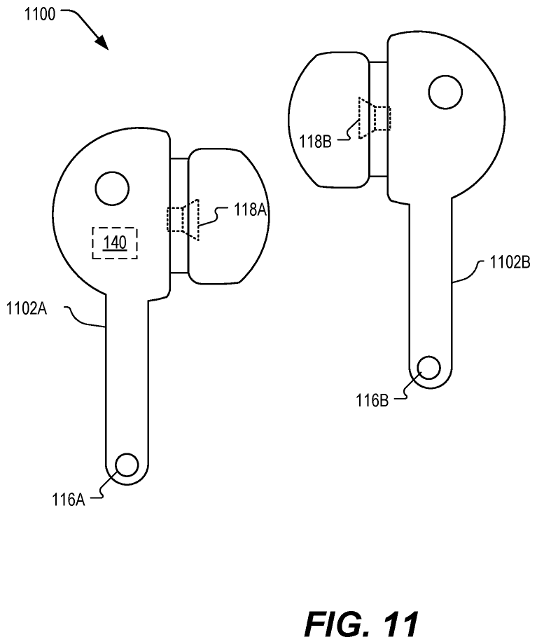

FIG. 11 depicts an implementation 1100 in which one of the devices 102 of FIG. 1 is a portable electronic device that corresponds to a pair of earbuds 1102 that includes a first earbud 1102A and a second earbud 1102B. Although earbuds are described, it should be understood that the present technology can be applied to other in-ear or over-ear playback devices.

At least one of the earbuds 1102 includes the microphone(s) 116, and each of the earbuds include at least one of the speaker(s) 118. For example, in FIG. 11, the first earbud 1102A includes the microphone 116A and the speaker 118A, and the second earbud 1102B includes the microphone 116B and the speaker 118B. The microphones 116 may include one or more high signal-to-noise microphones positioned to capture the voice of a wearer, an array of one or more other microphones configured to detect ambient sounds and spatially distributed to support beamforming, an “inner” microphone proximate to the wearer's ear canal (e.g., to assist with active noise cancelling), and a self-speech microphone, such as a bone conduction microphone configured to convert sound vibrations of the wearer's ear bone or skull into an audio signal, or any combination thereof.

In a particular example, components of the processor(s) 190, including the communication session manager 140, are integrated in at least one of the earbuds 1102 to enable the earbuds 1102 to control audio settings associated with a multidevice communication session. In this example, the earbuds 1102 are configured to receive transmissions from other devices that are participating in a multidevice communication session with the earbuds 1102. In this example, the communication session manager 140 is configured to determine, based on a transmission from another device participating in the multidevice communication session, data indicative of estimated acoustic coupling to the other device. The communication session manager 140 is further configured to cause the data indicative of the estimated acoustic coupling and an identifier of the multidevice communication session to be sent to an audio controller, and to receive, from the audio controller, an indicator of audio settings associated with the multidevice communication session. In implementations in which the communication session manager 140 of the earbuds 1102 includes the audio controller, the earbuds 1102 may also be operable to receive acoustic coupling data from the other devices participating in the multidevice communication session, to determine audio settings for one or more of the other devices, and to send an indication of the audio settings to the one or more other devices.

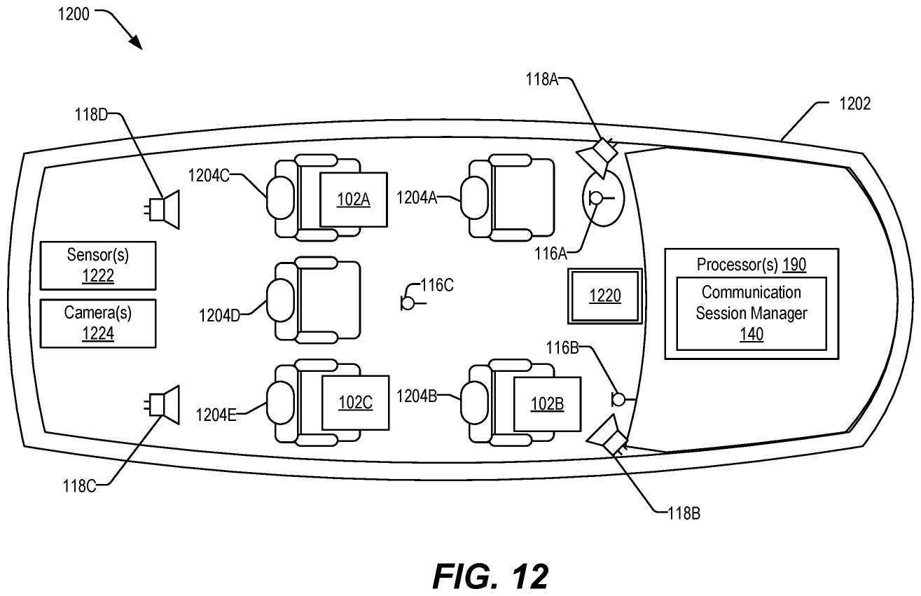

FIG. 12 depicts another implementation 1200 in which one of the devices 102 of FIG. 1 corresponds to, or is integrated within, a vehicle 1202, illustrated as a car. The vehicle 1202 includes a plurality of seats 1204, and optionally includes one or more cameras 1224 and/or one or more sensors 1222 configured to, for example, determine an arrangement of occupants within the vehicle 1202, identities of occupants of the vehicle 1202, etc. In the example illustrated in FIG. 12, the vehicle 1202 also includes the microphone(s) 116 and the speaker(s) 118 arranged about an interior of the vehicle 1202 to enable the occupants of the vehicle 1202 to participate in a multidevice communication session. The vehicle 1202 also optionally includes a display screen 1220. In FIG. 12, components of the processor(s) 190, including the communication session manager 140, are integrated in the vehicle 1202.

In the example illustrated in FIG. 12, the vehicle 1202 is configured to facilitate a multidevice communication session in which one or more occupants of the vehicle 1202 are participating using personal devices, such as devices 102A, 102B, and 102C. In a particular example, the communication session manager 140 of the vehicle 1202 is configured to receive transmissions from the devices 102 that are participating in the multidevice communication session. In this example, the communication session manager 140 is configured to determine, based on transmissions from the devices 102, data indicative of estimated acoustic coupling associated with the devices 102 (e.g., between the device 102, between the speaker(s) 118 and the devices 102, between the microphone(s) 116 and the devices 102, or a combination thereof). The communication session manager 140 is further configured to cause the data indicative of the estimated acoustic coupling and an identifier of the multidevice communication session to be sent to an audio controller, and to receive, from the audio controller, an indicator of audio settings associated with the multidevice communication session. In implementations in which the indicator of the audio settings includes a graphical element, the display screen 1220 is operable to display the graphical element to a user. In implementations in which the communication session manager 140 of the vehicle 1202 includes the audio controller, the vehicle 1202 may also be operable to receive acoustic coupling data from the devices 102 participating in the multidevice communication session, to determine audio settings for one or more of the devices 102, and to send an indication of the audio settings to the devices 102.

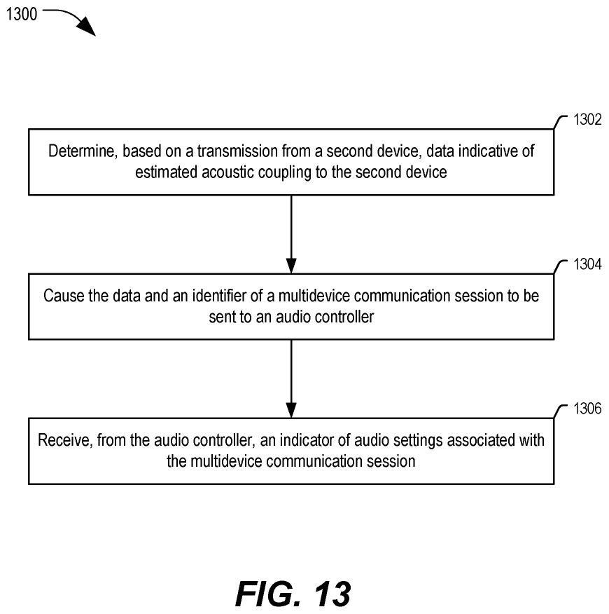

Referring to FIG. 13, a particular implementation of a method 1300 of controlling audio settings associated with multidevice communication sessions is shown. In a particular aspect, one or more operations of the method 1300 are performed by at least one of the devices 102 of FIG. 1, the communication server(s) 106, the communication session manager 140, the processor(s) 190, the system 100, one of the devices 202 of FIG. 3, or a combination thereof.

The method 1300 includes, at block 1302, determining (e.g., at a first device), based on a transmission from a second device, data indicative of estimated acoustic coupling to the second device. For example, the device 102A of FIG. 1 may receive the transmission(s) 170B from the device 102B and use the transmission(s) 170B to estimate acoustic coupling between the devices 102A and 102B. Additionally, or alternatively, the device 102A may receive the transmission(s) 170A from the device 102C and use the transmission(s) 170A to estimate acoustic coupling between the devices 102A and 102C.

In some implementations, the transmission(s) 170 include one or more advertisement packets, such as BLE advertisement packets. In some implementations, one or more of the transmission(s) 170 include a transmission power indicator 174 (and optionally an identifier of a multidevice communication session). The transmission power indicator 174 indicates a transmission power associated with the transmission. In such implementations, estimating acoustic coupling between devices 102 (e.g., between the device 102A and the device 102B) includes determining a received signal strength indicator based on the transmission power indicator.

In some implementations, the transmission(s) 170 include information indicating a location (e.g., a coordinate location) of the transmitting device, and the acoustic coupling is estimated based on the location of the transmitting device and a location of the receiving device.

The data indicative of the estimated acoustic coupling to the second device includes a qualitative or quantitative estimate of acoustic coupling. In a particular example, the data indicative of the estimated acoustic coupling to the second device includes a value indicative of acoustic coupling, such as one or more of a received signal strength indicator, a transmission power indicator and a received power indicator, position information associated with the second device, or an estimated distance to the second device. In another particular example, the data indicative of the estimated acoustic coupling to the second device includes a logical value indicating whether the estimated acoustic coupling exceeds a threshold.

The method 1300 also includes, at block 1304, causing the data and an identifier of a multidevice communication session to be sent to an audio controller. For example, the device 102A of FIG. 1 sends the session identifier 160A and the acoustic coupling data 162A to the audio controller 108. In some implementations, the audio controller is disposed at one or more media servers associated with the multidevice communication session. For example, the audio controller 108D of FIG. 1 corresponds to, includes, or is included within one or more media servers (e.g., communication server(s) 106) associated with the multidevice communication session. In other implementations, the audio controller is disposed at the second device. For example, the second device may correspond to the device 102B of FIG. 1, which optionally includes the audio controller 108B, or the second device may correspond to the device 102C of FIG. 1, which optionally includes the audio controller 108C. In still other implementations, the audio controller is a component of the first device. For example, the first device may correspond to the device 102A of FIG. 1, which optionally includes the audio controller 108A. In some implementations, the multidevice communication session includes a conference call or a video conference and the identifier of the multidevice communication session includes a call identifier or a conference identifier.

The method 1300 further includes, at block 1306, receiving, from the audio controller, an indicator of audio settings associated with the multidevice communication session. For example, the audio controller 108D of FIG. 1 may send the indicator 164A of the audio settings 156 to the device 102A. In this example, the audio controller 108D also sends the indicator 164B of the audio settings of the device 102B to the device 102B and sends the indicator 164C of the audio settings of the device 102C to the device 102C.

The audio controller selects the audio settings associated with the multidevice communication session to limit far-end echo due to co-location of multiple independently controllable audio output devices, multiple independently controllable audio input devices, or both, that are participating in the multidevice communication session. For example, the multiple independently controllable audio input devices may include microphones (e.g., the microphone 116) of several co-located devices, such as the devices 102 of FIG. 1 or the devices 202 of FIG. 1. Additionally, or alternatively, the multiple independently controllable audio output devices may include speakers (e.g., the speakers 118) of several co-located devices, such as the devices 102 of FIG. 1 or the devices 202 of FIG. 1. In some implementations, the audio controller determines the audio settings associated with the multidevice communication session to a establish a single audio output device and a single audio input device from among multiple co-located devices participating in the multidevice communication session. For example, the device 102A of FIG. 1 may be selected as the audio input device and the audio output device for the set of co-located devices 102 of FIG. 1. In this example, the devices 102B and 102C do not output sound associated with the multidevice communication session, and the multidevice communication session does not include sound captured at the device 102B or the device 102C.

In some implementations, the indicator of the audio settings includes one or more graphical elements indicating whether the audio controller is passing audio data from a particular device to other devices on the multidevice communication session. For example, the graphical element(s) sent to the second device (e.g., the device 102B of FIG. 1) may include a symbol, an icon, or another graphical element that indicates that the second device is muted (e.g., the communication server(s) 106 are not passing audio data from the device 102B to the remote devices 180 on the multidevice communication session) or is unmuted (e.g., the communication server(s) 106 are passing audio data from the device 102B to the remote devices 180 on the multidevice communication session).

In some implementations, the indicator of the audio settings includes one or more commands to adjust a gain associated with at least one audio transducer (e.g., one or more speakers, one or more microphones, or both) of the first device. In such implementations, the method 1300 may also include adjusting the gain associated with the at least one audio transducer responsive to the one or more commands. For example, the settings manager 146 of the device 102A can automatically adjust gain associated with the microphone(s) 116, gain associated with the speaker(s) 118, or both, responsive to one or more commands received via the indicator 164A of the audio settings 156 of the device 102A. As another example, the settings manager 146 of the device 102A can cause a prompt to be generated and presented to a user based on the one or more commands received via the indicator 164A of the audio settings 156 of the device 102A. To illustrate, the settings manager 146 of the device 102A can generate one or more prompts to request that a user of the first device (e.g., the device 102A) adjust the gain associated with the at least one audio transducer 114.

In some implementations, the method 1300 also includes, after receiving the indicator of the audio settings, monitoring audio data, generated by one or more microphones of the first device, based on detected sound. For example, the audio data monitor 144 of the device 102A of FIG. 1 may monitor the input sound 120A after the indicator 164A of the audio settings 156 is received. In this example, the audio data monitor 144 may monitor the input sound 120A even if audio data captured at the device 102A is not being passed to other devices associated with the multidevice communication session.

In such implementations, the method 1300 also includes, based on detecting one or more changes in the audio data, causing selection data based on the audio data to be sent to the audio controller and receiving, from the audio controller responsive to the selection data, an updated indicator of the audio settings associated with the multidevice communication session. For example, the change in the audio data may indicate that a person (e.g., the person 110A or the person 110B of FIG. 1) speaking during the multidevice communication session is moving or has moved, in which case the particular device or devices selected to capture audio data for the multidevice communication session may no longer be best placed to capture the audio data. In this situation, the audio controller can select a different device to capture the audio data for the multidevice communication session.

One benefit of the method 1300 is improved echo reduction due to the audio settings. For example, an echo canceller onboard a particular device is generally unable to reduce echo associated with other co-located devices. The audio settings are selected to reduce or avoid acoustic coupling, which also reduces echo experienced by far-end devices.

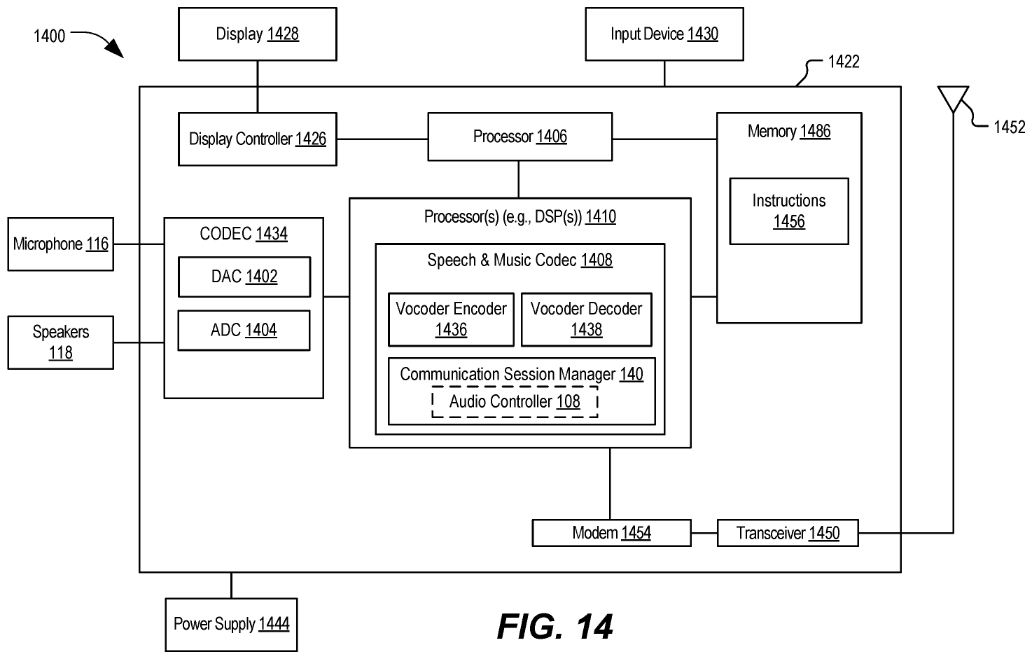

The method 1300 of FIG. 13 may be implemented by a field-programmable gate array (FPGA) device, an application-specific integrated circuit (ASIC), a processing unit such as a central processing unit (CPU), a DSP, a controller, another hardware device, firmware device, or any combination thereof. As an example, the method 1300 of FIG. 13 may be performed by a processor that executes instructions, such as described with reference to FIG. 14.

Referring to FIG. 14, a block diagram of a particular illustrative implementation of a device is depicted and generally designated 1400. In various implementations, the device 1400 may have more or fewer components than illustrated in FIG. 14. In an illustrative implementation, the device 1400 may correspond to, include, or be included within one of the devices 102 of FIG. 1, one of the communication server(s) 106 of FIG. 1, or one of the devices 202 of FIG. 2. In an illustrative implementation, the device 1400 may perform one or more operations described with reference to FIGS. 1-13.

In a particular implementation, the device 1400 includes a processor 1406 (e.g., a central processing unit (CPU)). The device 1400 may include one or more additional processors 1410 (e.g., one or more DSPs). In a particular aspect, the processor(s) 190 of FIG. 1 correspond to the processor 1406, the processor(s) 1410, or a combination thereof. The processor(s) 1410 may include a speech and music coder-decoder (CODEC) 1408 that includes a voice coder (“vocoder”) encoder 1436, a vocoder decoder 1438, the communication session manager 140, the audio controller 108, or a combination thereof. In implementations in which the device 1400 corresponds to one of the communication server(s) 106 of FIG. 1, components of the communication session manager 140 other than the audio controller 108 can optionally be omitted. In implementations in which the device 1400 corresponds to one of the devices 102 of FIG. 1 or one of the devices 202 of FIG. 2, the audio controller 108 can optionally be omitted from the communication session manager 140.

The device 1400 may include a memory 1486 and a CODEC 1434. The memory 1486 may include instructions 1456, that are executable by the one or more additional processors 1410 (or the processor 1406) to implement the functionality described with reference to the communication session manager 140, the audio controller 108, or both. For example, the memory 1486 may include or correspond to the memory 150 of FIG. 1, in which case, the instructions 1456 may include or correspond to the instructions 152 of FIG. 1.

The device 1400 may include the modem 1454 coupled, via a transceiver 1450, to an antenna 1452. In implementations in which the device 1400 corresponds to one of the devices 102 of FIG. 1, the modem 1454 corresponds to the modem 132 of FIG. 1, and the transceiver 1450 corresponds to the transceiver 134 of FIG. 1.

The device 1400 may include a display 1428 coupled to a display controller 1426. In implementations in which the device 1400 corresponds to one of the devices 102 of FIG. 1, the speaker(s) 118 and the microphone(s) 116 are coupled to the CODEC 1434. The CODEC 1434 may include a digital-to-analog converter (DAC) 1402, an analog-to-digital converter (ADC) 1404, or both. In a particular implementation, the CODEC 1434 may receive analog signals from the microphone(s) 116, convert the analog signals to digital signals using the analog-to-digital converter 1404, and provide the digital signals to the speech and music codec 1408. The speech and music codec 1408 may process the digital signals, and the digital signals may further be processed by the communication session manager 140. In a particular implementation, the speech and music codec 1408 may provide digital signals to the CODEC 1434. The CODEC 1434 may convert the digital signals to analog signals using the digital-to-analog converter 1402 and may provide the analog signals to the speaker(s) 118.

In a particular implementation, the device 1400 may be included in a system-in-package or system-on-chip device 1422. In a particular implementation, the memory 1486, the processor 1406, the processor(s) 1410, the display controller 1426, the CODEC 1434, the modem 1454, and optionally the transceiver 1450 are included in the system-in-package or system-on-chip device 1422. In a particular implementation, an input device 1430 and a power supply 1444 are coupled to the system-in-package or the system-on-chip device 1422. Moreover, in a particular implementation, as illustrated in FIG. 14, the display 1428, the input device 1430, the speaker(s) 118, the microphone(s) 116, the antenna 1452, and the power supply 1444 are external to the system-in-package or the system-on-chip device 1422. In a particular implementation, each of the display 1428, the input device 1430, the speaker(s) 118, the microphone(s) 116, the antenna 1452, and the power supply 1444 may be coupled to a component of the system-in-package or the system-on-chip device 1422, such as an interface or a controller.

The device 1400 may include a conference call or video call control device, a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an extended reality headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus includes means for determining data indicative of estimated acoustic coupling of a first device to a second device, where the data is based on a transmission from the second device. For example, the means for determining data indicative of estimated acoustic coupling can correspond to one of the devices 102 of FIG. 1, the processor(s) 190, the communication session manager 140, one of the devices 202 of FIG. 2, the integrated circuit 302 of FIG. 3, the device 1400 of FIG. 14, the processor 1406, the processor(s) 1410, one or more other circuits or components configured to determine data indicative of estimated acoustic coupling, or any combination thereof.

The apparatus also includes means for causing the data and an identifier of a multidevice communication session to be sent to an audio controller. For example, the means for causing the data and the identifier of the multidevice communication session to be sent to the audio controller can correspond to one of the devices 102 of FIG. 1, the processor(s) 190, the communication session manager 140, the modem 132, the transceiver 134, the communication circuitry 130, one of the devices 202 of FIG. 2, the integrated circuit 302 of FIG. 3, the device 1400 of FIG. 14, the processor 1406, the processor(s) 1410, the modem 1454, the transceiver 1450, one or more other circuits or components configured to cause the data and the identifier of the multidevice communication session to be sent to the audio controller, or any combination thereof.

The apparatus also includes means for receiving, from the audio controller, an indicator of audio settings associated with the multidevice communication session. For example, the means for receiving the indicator of audio settings can correspond to one of the devices 102 of FIG. 1, the processor(s) 190, the communication session manager 140, the modem 132, the transceiver 134, the communication circuitry 130, one of the devices 202 of FIG. 2, the integrated circuit 302 of FIG. 3, the device 1400 of FIG. 14, the processor 1406, the processor(s) 1410, the modem 1454, the transceiver 1450, one or more other circuits or components configured to receive the indicator of audio settings, or any combination thereof.

In some implementations, a non-transitory computer-readable medium (e.g., a computer-readable storage device, such as the memory 150 or the memory 1486) includes instructions (e.g., the instructions 152 or the instructions 1456) that, when executed by one or more processors (e.g., the processor(s) 190, the processor(s) 1410, or the processor 1406), cause the one or more processors to determine, based on a transmission from a second device, data indicative of estimated acoustic coupling to the second device, cause the data and an identifier of a multidevice communication session to be sent to an audio controller, and receive, from the audio controller, an indicator of audio settings associated with the multidevice communication session.

Particular aspects of the disclosure are described below in sets of interrelated Examples:

According to Example 1, a device includes one or more processors configured to: determine, based on a transmission from a second device, data indicative of estimated acoustic coupling to the second device; cause the data and an identifier of a multidevice communication session to be sent to an audio controller; and receive, from the audio controller, an indicator of audio settings associated with the multidevice communication session.

Example 2 includes the device of Example 1, wherein the transmission includes a transmission power indicator, wherein determining the data indicative of the estimated acoustic coupling to the second device includes determining a received signal strength indicator based on the transmission power indicator, wherein the multidevice communication session includes a conference call and the identifier of the multidevice communication session includes a call identifier, and wherein the audio controller corresponds to, includes, or is included within one or more media servers associated with the multidevice communication session.

Example 3 includes the device of Example 1 or Example 2, wherein the data indicative of the estimated acoustic coupling to the second device includes one or more of a received signal strength indicator, a transmission power indicator and a received power indicator, position information associated with the second device, or an estimated distance to the second device.

Example 4 includes the device of any of Examples 1 to 3, wherein the transmission includes a transmission power indicator and the identifier of the multidevice communication session.

Example 5 includes the device of any of Examples 1 to 4, wherein the transmission includes one or more advertisement packets.

Example 6 includes the device of any of Examples 1 to 5, further including a modem coupled to the one or more processors, the modem configured to send the data and the identifier of the multidevice communication session to the audio controller via one or more network connections.

Example 7 includes the device of any of Examples 1 to 6, wherein the audio controller is disposed at one or more media servers associated with the multidevice communication session.

Example 8 includes the device of any of Examples 1 to 6, wherein the audio controller is disposed at the second device.

Example 9 includes the device of any of Examples 1 to 6, further including the audio controller.

Example 10 includes the device of any of Examples 1 to 9, further including one or more microphones coupled to the one or more processors and configured to generate audio data based on detected sound, and wherein the indicator of the audio settings includes one or more graphical elements indicating that the audio controller is not passing the audio data to other devices on the multidevice communication session.

Example 11 includes the device of any of Examples 1 to 10, wherein the indicator of the audio settings includes one or more graphical elements indicating that the audio controller is not passing, to one or more other devices on the multidevice communication session, audio data from the second device.

Example 12 includes the device of any of Examples 1 to 11, further including one or more audio transducers coupled to the one or more processors, wherein the indicator of the audio settings includes one or more commands to adjust a gain associated with at least one audio transducer of the one or more audio transducers.

Example 13 includes the device of Example 12, wherein the one or more audio transducers include one or more speakers, one or more microphones, or both.

Example 14 includes the device of Example 12 or Example 13, wherein the one or more processors are further configured to automatically adjust the gain associated with the at least one audio transducer responsive to the one or more commands.

Example 15 includes the device of any of Examples 12 to 14, wherein the one or more processors are further configured to, responsive to the one or more commands, generate one or more prompts to request that a user adjust the gain associated with the at least one audio transducer.

Example 16 includes the device of any of Examples 1 to 15, wherein the audio settings associated with the multidevice communication session are selected to limit far end echo due to co-location of multiple independently controllable audio output devices, multiple independently controllable audio input devices, or both, that are participating in the multidevice communication session.

Example 17 includes the device of any of Examples 1 to 16, wherein the audio settings associated with the multidevice communication session establish a single audio output device and a single audio input device from among multiple co-located devices participating in the multidevice communication session.

Example 18 includes the device of Example 17, further including one or more microphones coupled to the one or more processors and configured to generate audio data based on detected sound, wherein the one or more processors are further configured to, after receiving the indicator of the audio settings: monitor the audio data; based on detecting one or more changes in the audio data, cause selection data based on the audio data to be sent to the audio controller; and receive, from the audio controller responsive to the selection data, an updated indicator of the audio settings associated with the multidevice communication session.

Example 19 includes the device of any of Examples 1 to 18, wherein the one or more processors are integrated within a mobile computing device.

Example 20 includes the device of any of Examples 1 to 18, wherein the one or more processors are integrated within a wearable device.

Example 21 includes the device of any of Examples 1 to 18, wherein the one or more processors are integrated within a portable communication device.

Example 22 includes the device of any of Examples 1 to 18, wherein the one or more processors are integrated within a headset device.

According to Example 23, a method includes: determining, by one or more processors of a first device, data indicative of estimated acoustic coupling to a second device, the data based on a transmission from the second device; causing the data and an identifier of a multidevice communication session to be sent to an audio controller; and receiving, from the audio controller, an indicator of audio settings associated with the multidevice communication session.

Example 24 includes the method of Example 23, wherein the transmission includes a transmission power indicator, wherein determining the data indicative of the estimated acoustic coupling to the second device includes determining a received signal strength indicator based on the transmission power indicator, wherein the multidevice communication session includes a conference call and the identifier of the multidevice communication session includes a call identifier, and wherein the audio controller corresponds to, includes, or is included within one or more media servers associated with the multidevice communication session.

Example 25 includes the method of Example 23 or Example 24, wherein the data indicative of the estimated acoustic coupling to the second device includes one or more of a received signal strength indicator, a transmission power indicator and a received power indicator, position information associated with the second device, or an estimated distance to the second device.

Example 26 includes the method of any of Examples 23 to 25, wherein the transmission includes a transmission power indicator and the identifier of the multidevice communication session.

Example 27 includes the method of any of Examples 23 to 26, wherein the transmission includes one or more advertisement packets.

Example 28 includes the method of any of Examples 23 to 27, wherein the audio controller is disposed at one or more media servers associated with the multidevice communication session.

Example 29 includes the method of any of Examples 23 to 27, wherein the audio controller is disposed at the second device.

Example 30 includes the method of any of Examples 23 to 27, wherein the audio controller is a component of the first device.

Example 31 includes the method of any of Examples 23 to 30, further including generating, at one or more microphones of the first device, audio data based on detected sound, and wherein the indicator of the audio settings includes one or more graphical elements indicating that the audio controller is not passing the audio data to other devices on the multidevice communication session.

Example 32 includes the method of any of Examples 23 to 31, wherein the indicator of the audio settings includes one or more graphical elements indicating that the audio controller is not passing, to one or more other devices on the multidevice communication session, audio data from the second device.

Example 33 includes the method of any of Examples 23 to 32, wherein the indicator of the audio settings includes one or more commands to adjust a gain associated with at least one audio transducer of the first device.

Example 34 includes the method of Example 33, wherein the at least one audio transducer includes one or more speakers, one or more microphones, or both.

Example 35 includes the method of Example 33 or Example 34, further including adjusting the gain associated with the at least one audio transducer responsive to the one or more commands.

Example 36 includes the method of any of Examples 33 to 35, further including generating one or more prompts to request that a user of the first device adjust the gain associated with the at least one audio transducer.

Example 37 includes the method of any of Examples 23 to 36, wherein the audio settings associated with the multidevice communication session are selected to limit far end echo due to co-location of multiple independently controllable audio output devices, multiple independently controllable audio input devices, or both, that are participating in the multidevice communication session.

Example 38 includes the method of any of Examples 23 to 37, wherein the audio settings associated with the multidevice communication session establish a single audio output device and a single audio input device from among multiple co-located devices participating in the multidevice communication session.

Example 39 includes the method of Example 38, further including, after receiving the indicator of the audio settings: monitoring audio data, generated by one or more microphones of the first device, based on detected sound; based on detecting one or more changes in the audio data, causing selection data based on the audio data to be sent to the audio controller; and receiving, from the audio controller responsive to the selection data, an updated indicator of the audio settings associated with the multidevice communication session.

According to Example 40, a device includes: a memory configured to store instructions; and a processor configured to execute the instructions to perform the method of any of Example 23 to 39.

According to Example 41, a non-transitory computer-readable medium stores instructions that, when executed by a processor, cause the processor to perform the method of any of Example 23 to Example 39.

According to Example 42, an apparatus includes means for carrying out the method of any of Example 23 to Example 39.

According to Example 43, a non-transitory computer-readable medium stores instructions that are executable by one or more processors to cause the one or more processors to: determine, based on a transmission from a second device, data indicative of estimated acoustic coupling to the second device; cause the data and an identifier of a multidevice communication session to be sent to an audio controller; and receive, from the audio controller, an indicator of audio settings associated with the multidevice communication session.

Example 44 includes the non-transitory computer-readable medium of Example 43, wherein the transmission includes a transmission power indicator, wherein determining the data indicative of the estimated acoustic coupling to the second device includes determining a received signal strength indicator based on the transmission power indicator, wherein the multidevice communication session includes a conference call and the identifier of the multidevice communication session includes a call identifier, and wherein the audio controller corresponds to, includes, or is included within one or more media servers associated with the multidevice communication session.

Example 45 includes the non-transitory computer-readable medium of Example 43 or Example 44, wherein the data indicative of the estimated acoustic coupling to the second device includes one or more of a received signal strength indicator, a transmission power indicator and a received power indicator, position information associated with the second device, or an estimated distance to the second device.

Example 46 includes the non-transitory computer-readable medium of any of Examples 43 to 45, wherein the transmission includes a transmission power indicator and the identifier of the multidevice communication session.

Example 47 includes the non-transitory computer-readable medium of any of Examples 43 to 46, wherein the transmission includes one or more advertisement packets.

Example 48 includes the non-transitory computer-readable medium of any of Examples 43 to 47, wherein the instructions are further executable to send the data and the identifier of the multidevice communication session to the audio controller via one or more network connections.

Example 49 includes the non-transitory computer-readable medium of any of Examples 43 to 48, wherein the audio controller is disposed at one or more media servers associated with the multidevice communication session.

Example 50 includes the non-transitory computer-readable medium of any of Examples 43 to 48, wherein the audio controller is disposed at the second device.

Example 51 includes the non-transitory computer-readable medium of any of Examples 43 to 50, wherein the instructions are further executable to generate audio data based on detected sound, and wherein the indicator of the audio settings includes one or more graphical elements indicating that the audio controller is not passing the audio data to other devices on the multidevice communication session.

Example 52 includes the non-transitory computer-readable medium of any of Examples 43 to 51, wherein the indicator of the audio settings includes one or more graphical elements indicating that the audio controller is not passing, to one or more other devices on the multidevice communication session, audio data from the second device.

Example 53 includes the non-transitory computer-readable medium of any of Examples 43 to 52, wherein the instructions are further executable to adjust a gain associated with at least one audio transducer based on one or more commands in the indicator of the audio settings.

Example 54 includes the non-transitory computer-readable medium of Example 53, wherein the one or more audio transducers include one or more speakers, one or more microphones, or both.

Example 55 includes the non-transitory computer-readable medium of Example 53 or Example 54, wherein the instructions are further executable to adjust the gain associated with the at least one audio transducer responsive to the one or more commands.

Example 56 includes the non-transitory computer-readable medium of any of Examples 53 to 55, wherein the instructions are further executable to, responsive to the one or more commands, generate one or more prompts to request that a user adjust the gain associated with the at least one audio transducer.

Example 57 includes the non-transitory computer-readable medium of any of Examples 43 to 56, wherein the audio settings associated with the multidevice communication session are selected to limit far end echo due to co-location of multiple independently controllable audio output devices, multiple independently controllable audio input devices, or both, that are participating in the multidevice communication session.

Example 58 includes the non-transitory computer-readable medium of any of Examples 43 to 57, wherein the audio settings associated with the multidevice communication session establish a single audio output device and a single audio input device from among multiple co-located devices participating in the multidevice communication session.

Example 59 includes the non-transitory computer-readable medium of Example 58, wherein the instructions are further executable to: generate audio data based on detected sound after receiving the indicator of the audio settings; based on detecting one or more changes in the audio data, cause selection data based on the audio data to be sent to the audio controller; and receive, from the audio controller responsive to the selection data, an updated indicator of the audio settings associated with the multidevice communication session.

According to Example 60, an apparatus includes: means for determining data indicative of estimated acoustic coupling of a first device to a second device, the data based on a transmission from the second device; means for causing the data and an identifier of a multidevice communication session to be sent to an audio controller; and means for receiving, from the audio controller, an indicator of audio settings associated with the multidevice communication session.

Example 61 includes the apparatus of Example 60, wherein the transmission includes a transmission power indicator, wherein determining the data indicative of the estimated acoustic coupling to the second device includes determining a received signal strength indicator based on the transmission power indicator, wherein the multidevice communication session includes a conference call and the identifier of the multidevice communication session includes a call identifier, and wherein the audio controller corresponds to, includes, or is included within one or more media servers associated with the multidevice communication session.

Example 62 includes the apparatus of Example 60 or Example 61, wherein the data indicative of the estimated acoustic coupling to the second device includes one or more of a received signal strength indicator, a transmission power indicator and a received power indicator, position information associated with the second device, or an estimated distance to the second device.

Example 63 includes the apparatus of any of Examples 60 to 62, wherein the transmission includes a transmission power indicator and the identifier of the multidevice communication session.

Example 64 includes the apparatus of any of Examples 60 to 63, wherein the transmission includes one or more advertisement packets.

Example 65 includes the apparatus of any of Examples 60 to 64, further including means for sending the data and the identifier of the multidevice communication session to the audio controller via one or more network connections.

Example 66 includes the apparatus of any of Examples 60 to 65, wherein the audio controller is disposed at one or more media servers associated with the multidevice communication session.

Example 67 includes the apparatus of any of Examples 60 to 65, wherein the audio controller is disposed at the second device.

Example 68 includes the apparatus of any of Examples 60 to 65, wherein the audio controller is a component of the first device.

Example 69 includes the apparatus of any of Examples 60 to 68, further including means for generating audio data based on sound detected at the first device, and wherein the indicator of the audio settings includes one or more graphical elements indicating that the audio controller is not passing the audio data to other devices on the multidevice communication session.

Example 70 includes the apparatus of any of Examples 60 to 69, wherein the indicator of the audio settings includes one or more graphical elements indicating that the audio controller is not passing, to one or more other devices on the multidevice communication session, audio data from the second device.

Example 71 includes the apparatus of any of Examples 60 to 70, wherein the indicator of the audio settings includes one or more commands to adjust a gain associated with at least one audio transducer of the first device.

Example 72 includes the apparatus of Example 71, wherein the at least one audio transducer includes one or more speakers, one or more microphones, or both.

Example 73 includes the apparatus of Example 71 or Example 72, further including means for adjusting the gain associated with the at least one audio transducer responsive to the one or more commands.

Example 74 includes the apparatus of any of Examples 71 to 73, further including means for generating one or more prompts to request that a user of the first device adjust the gain associated with the at least one audio transducer.

Example 75 includes the apparatus of any of Examples 60 to 74, wherein the audio settings associated with the multidevice communication session are selected to limit far end echo due to co-location of multiple independently controllable audio output devices, multiple independently controllable audio input devices, or both, that are participating in the multidevice communication session.

Example 76 includes the apparatus of any of Examples 60 to 75, wherein the audio settings associated with the multidevice communication session establish a single audio output device and a single audio input device from among multiple co-located devices participating in the multidevice communication session.

Example 77 includes the apparatus of Example 76, further including: means for monitoring audio data, generated by one or more microphones of the first device after receiving the indicator of the audio settings, based on detected sound; means for causing, based on detecting one or more changes in the audio data, selection data based on the audio data to be sent to the audio controller; and means for receiving, from the audio controller responsive to the selection data, an updated indicator of the audio settings associated with the multidevice communication session.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
one or more processors configured to:
determine, based on a transmission from a second device, data indicative of estimated acoustic coupling to the second device;
cause the data and an identifier of a multidevice communication session to be sent to an audio controller; and
receive, from the audio controller, an indicator of audio settings associated with the multidevice communication session.

2. The device of claim 1, wherein the transmission includes a transmission power indicator, wherein determining the data indicative of the estimated acoustic coupling to the second device includes determining a received signal strength indicator based on the transmission power indicator, wherein the multidevice communication session includes a conference call and the identifier of the multidevice communication session includes a call identifier, and wherein the audio controller corresponds to, includes, or is included within one or more media servers associated with the multidevice communication session.

3. The device of claim 1, wherein the data indicative of the estimated acoustic coupling to the second device includes one or more of a received signal strength indicator, a transmission power indicator and a received power indicator, position information associated with the second device, or an estimated distance to the second device.

4. The device of claim 1, wherein the transmission includes a transmission power indicator and the identifier of the multidevice communication session.

5. The device of claim 1, wherein the transmission includes one or more advertisement packets.

6. The device of claim 1, further comprising a modem coupled to the one or more processors, the modem configured to send the data and the identifier of the multidevice communication session to the audio controller via one or more network connections.

7. The device of claim 1, wherein the audio controller is disposed at the second device or at one or more media servers associated with the multidevice communication session.

8. The device of claim 1, further comprising the audio controller.

9. The device of claim 1, further comprising one or more microphones coupled to the one or more processors and configured to generate audio data based on detected sound, and wherein the indicator of the audio settings includes one or more graphical elements indicating that the audio controller is not passing the audio data to other devices on the multidevice communication session.

10. The device of claim 1, further comprising one or more audio transducers coupled to the one or more processors, wherein the indicator of the audio settings includes one or more commands to adjust a gain associated with at least one audio transducer of the one or more audio transducers.

11. The device of claim 10, wherein the one or more processors are further configured to automatically adjust the gain associated with the at least one audio transducer responsive to the one or more commands.

12. The device of claim 10, wherein the one or more processors are further configured to, responsive to the one or more commands, generate one or more prompts to request that a user adjust the gain associated with the at least one audio transducer.

13. The device of claim 1, wherein the audio settings associated with the multidevice communication session are selected to limit far end echo due to co-location of multiple independently controllable audio output devices, multiple independently controllable audio input devices, or both, that are participating in the multidevice communication session.

14. The device of claim 1, wherein the audio settings associated with the multidevice communication session establish a single audio output device and a single audio input device from among multiple co-located devices participating in the multidevice communication session.

15. The device of claim 14, further comprising one or more microphones coupled to the one or more processors and configured to generate audio data based on detected sound, wherein the one or more processors are further configured to, after receiving the indicator of the audio settings:
monitor the audio data;
based on detecting one or more changes in the audio data, cause selection data based on the audio data to be sent to the audio controller; and
receive, from the audio controller responsive to the selection data, an updated indicator of the audio settings associated with the multidevice communication session.

16. The device of claim 1, wherein the one or more processors are integrated within one or more of a mobile computing device, a wearable device, a portable communication device, or a headset device.

17. A method comprising:
determining, by one or more processors of a first device, data indicative of estimated acoustic coupling to a second device, the data based on a transmission from the second device;
causing the data and an identifier of a multidevice communication session to be sent to an audio controller; and
receiving, from the audio controller, an indicator of audio settings associated with the multidevice communication session.

18. The method of claim 17, wherein the transmission includes a transmission power indicator, wherein determining the data indicative of the estimated acoustic coupling to the second device includes determining a received signal strength indicator based on the transmission power indicator, wherein the multidevice communication session includes a conference call and the identifier of the multidevice communication session includes a call identifier, and wherein the audio controller corresponds to, includes, or is included within one or more media servers associated with the multidevice communication session.

19. The method of claim 17, wherein the data indicative of the estimated acoustic coupling to the second device includes one or more of a received signal strength indicator, a transmission power indicator and a received power indicator, position information associated with the second device, or an estimated distance to the second device.

20. The method of claim 17, wherein the indicator of the audio settings includes one or more graphical elements indicating that the audio controller is not passing, to one or more other devices on the multidevice communication session, audio data from the second device.

21. The method of claim 17, wherein the indicator of the audio settings includes one or more commands to adjust a gain associated with at least one audio transducer of the first device.

22. A non-transitory computer-readable medium storing instructions that are executable by one or more processors to cause the one or more processors to:
determine, based on a transmission from a second device, data indicative of estimated acoustic coupling to the second device;
cause the data and an identifier of a multidevice communication session to be sent to an audio controller; and
receive, from the audio controller, an indicator of audio settings associated with the multidevice communication session.

23. The non-transitory computer-readable medium of claim 22, wherein the transmission includes a transmission power indicator, wherein determining the data indicative of the estimated acoustic coupling to the second device includes determining a received signal strength indicator based on the transmission power indicator, wherein the multidevice communication session includes a conference call and the identifier of the multidevice communication session includes a call identifier, and wherein the audio controller corresponds to, includes, or is included within one or more media servers associated with the multidevice communication session.

24. The non-transitory computer-readable medium of claim 22, wherein the data indicative of the estimated acoustic coupling to the second device includes one or more of a received signal strength indicator, a transmission power indicator and a received power indicator, position information associated with the second device, or an estimated distance to the second device.

25. The non-transitory computer-readable medium of claim 22, wherein the transmission includes a transmission power indicator and the identifier of the multidevice communication session.

26. The non-transitory computer-readable medium of claim 22, wherein the transmission includes one or more advertisement packets.

27. The non-transitory computer-readable medium of claim 22, wherein the instructions are further executable to send the data and the identifier of the multidevice communication session to the audio controller via one or more network connections.

28. The non-transitory computer-readable medium of claim 22, wherein the instructions are further executable to generate audio data based on detected sound, and wherein the indicator of the audio settings includes one or more graphical elements indicating that the audio controller is not passing the audio data to other devices on the multidevice communication session.

29. An apparatus comprising:
means for determining data indicative of estimated acoustic coupling of a first device to a second device, the data based on a transmission from the second device;
means for causing the data and an identifier of a multidevice communication session to be sent to an audio controller; and
means for receiving, from the audio controller, an indicator of audio settings associated with the multidevice communication session.

30. The apparatus of claim 29, further comprising:
means for monitoring audio data, generated by one or more microphones of the first device after receiving the indicator of the audio settings, based on detected sound;
means for causing, based on detecting one or more changes in the audio data, selection data based on the audio data to be sent to the audio controller; and
means for receiving, from the audio controller responsive to the selection data, an updated indicator of the audio settings associated with the multidevice communication session.
